(19) United States
(12) Patent Application Publication
(10) Pub. No.: US 2011/0189553 A1
(43) Pub. Date: Aug. 4, 2011

(54) METHOD FOR PRODUCING AND INTEGRATION OF DIRECT SODIUM BOROHYDRIDE FUEL CELL

(75) Inventors: Fatma Gül Boyacisan, Kocaeli (TR); Gamze Behmenyar, Kocaeli (TR); Selahattin Uysal, Kocaeli (TR); Betul Erdör, Kocaeli (TR); Fatih Genc, Kocaeli (TR); Sener Tansel, Kocaeli (TR); Emin Okumus, Kocaeli (TR); Osman Okur, Kocaeli (TR); Ismail Bican, Kocaeli (TR)

(73) Assignee: TUBITAK-SCIENTIFIC AND TECHONOLOGICAL RESEARCH COUNCIL OF TURKEY, Kavaklidere (TR)

(21) Appl. No.: 13/059,887

(22) PCT Filed: Aug. 19, 2009
(86) PCT No.: PCT/IB2009/053652

§ 371 Date: Apr. 18, 2011

(30) Foreign Application Priority Data
Aug. 19, 2008 (TR) 2008/06202

(51) Int. Cl. H01M 8/24; H01M 8/06; H01M 8/04

(52) U.S. Cl. 429/410; 429/457; 429/415

(57) ABSTRACT

In the related invention, for different applications, the system integration of a 70-150 W functional and portable direct sodium borohydride fuel cell (DSBHFC) is realized. The system is integrated in such a way that neither the hydrogen from the sodium borohydride fuel nor the oxygen from the oxidant hydrogen peroxide affects the fuel cell performance. The 70-150 W power system consists of 4 different groups. Each group has two stacks with 7 cells. Therefore, each group has a total of 14 cells. The system altogether has 56 cells. The fuel and the oxidant pumped from the storage tanks are sent to the distributing unit through the anode and cathode lines. In the distributor, anode and cathode flows distributed to every feeding line for each stack reach the cells through the distribution lines. The fuel and oxidant solutions in the stack reach the collecting units through the collecting lines. The flows are sent back form the collecting units to the feeding tank. In this way, the circulation of fuel and oxidant in tanks for each 7-cell group is realized and the performance is increased.

### BACKGROUND ART

1. Technical Field

The present invention relates to the system integration of a functional and portable 70-150 W direct sodium borohydride fuel cell.

2. Background Art

Fuel cells are electrochemical devices that convert chemical energy of the reaction directly to electrical energy. The physical structure of a fuel cell consists of an electrolyte layer that is in contact with a porous anode and a porous cathode. In a typical fuel cell, the fuel is continuously fed to the anode (the negative electrode) and the oxidant (oxygen/air) is continuously fed to the cathode (the positive electrode). Fuel cells are categorized into 6 groups such as the polymer electrolyte membrane fuel cell (PEM), the direct methanol fuel cell (DMFC), the alkaline fuel cell (AFC), the phosphoric acid fuel cell (PAFC), the molten carbonate fuel cell (MCFC), and the solid oxide fuel cell (SOFC).

Fuel cells have a wide variety of application areas such as portable electronics, vehicles, electricity/heat production plants, as well as military and civil institutions. At this point it must be emphasized that hydrogen storage is a serious problem. For this purpose, sodium borohydride manufactured from the boron minerals is known as one of the most important hydrogen storage agents.

The aqueous alkaline solutions of sodium borohydride are catalytically decomposed to release the stored hydrogen. Sodium borohydride can store up to %20 (by weight) hydrogen and is not flammable or explosive. The hydrogen production rate can easily be controlled. Half of the emerging hydrogen comes from the hydride and the other half comes from water. The catalyst and sodium metaborate can be recycled and used again. In the fuel cell, either hydrogen is produced first in situ and used as such or sodium borohydride can be used directly as fuel. Especially in portable fuel cell applications, the direct sodium borohydride fuel cell (DSBHFC) is a good alternative to the direct methanol fuel cell (DMFC). When the direct methanol and sodium borohydride fuel cells are compared, the potential, theoretical specific capacity, and energy density are 1.24 V, 5030 A hour/kg and 6200 Whour/kg, respectively for direct methanol fuel cells whereas for direct sodium borohydride fuel cells, these values are 1.64 V, 5667 A hour/kg, and 9285 W hour/kg. In addition, DMFC has some drawbacks because of poor anode kinetics, the poisoning effects of methanol, and the cross-over from the anode to the cathode. Turkey has almost 70% of the proven boron reserves of the world of the highest quality. A direct sodium borohydride fuel cell consists of electrocatalyst layers (anode and cathode), an electrolyte (membrane) (combination of membrane and electrodes is called MEA), a bipolar plate, a current collector plate, gasket and other joining elements. A fuel cell stack is manufactured by combining a sufficient number of cells to meet the power requirements.

Fuel cell stacks have different designs depending on their applications, power, and potential requirements. These designs are bipolar, pseudo bipolar, and mopolar stack designs. Also, each type can be classified into sub-groups depending on the differences in stack design for air feeding and humidification. The bipolar stack design is the best one for high power (100 W-1 MW) requirements in PEM fuel cells. Water and heat managements are playing an important role in bipolar stack designs. Pseudo bipolar stack design is suitable for power levels of 20-150 W, and humidification is needed in these stacks. Mopolar design is suitable for low power (1-50 W) and high potential devices. Humidification and temperature control are important in mopolar system design. Depending on the type of applications pseudo bipolar and bipolar stack designs can be used in each other's place. Mopolar design is more suitable for devices like computers , which have wide surface areas in the assembly.

Especially in liquid fuel cell systems, the products and the by-products emerging during the reaction are extremely important in stack design. In fuel cells in which a gas product and by-products are formed, it is very important whether the plates are connected in series or parallel as this connection type affects the performance a great deal.

There are various patents on sodium borohydride fuel cells. Most of these patents are related to the hydrolysis of sodium borohydride and the utilization of hydrogen which is formed from hydrolysis reaction. The first article in fuel cells published by Schlesinger et al in 1953 is about the production of hydrogen from sodium borohydride.

In U.S. Pat. No. 559,640, a fuel cell in which alkaline solutions of some hydrides such as NaBH₄, KBH₄, LiAlH₄, KH and NaH giving out hydrogen are used, was mentioned for the first time. In this fuel cell, a membrane electrolyte does not exist. Amendola et al reported in 1999 that they could reach over 60 mW/cm² power density at 70° C. with a sodium borohydride fuel cell in which an anion exchange membrane is used.

Patents US 2004052722, U.S. Pat. No. 7,045,230, U.S. Pat. No. 7,105,033, U.S. Pat. No. 7,083,657, US 68118334, U.S. Pat. No. 6,339,529, U.S. Pat. No. 6,932,847, U.S. Pat. No. 6,727,012, U.S. Pat. No. 6,683,025, U.S. Pat. No. 6,534,033, U.S. Pat. No. 6,946,104, US 654400, JP 2004349029, JP2004244262, JP2006069869, JP200658753, JP2007012319, JP2006069869 are related to hydrogen production from borohydride, and the feeding of this hydrogen to the fuel cell.

In Patent No KR 2004008897, it is reported that the direct sodium borohydride fuel cell consists of an anionic polymer separator and an alkaline electrolyte with pH greater than 13, coupled with an air electrode and a fuel electrode to which a % 10-40 Na Ba₄ aqueous solution is fed. In Patent No US200721258 it is mentioned that a direct liquid fed fuel cell consists of a gel electrolyte and a liquid fuel, and that the liquid fuel is metal hydride and/or borohydride compounds.

In fuel cells, usually air or oxygen is used as the oxidant. Besides these, hydrogen peroxide can also be used as the oxidant. There are various patents regarding the use of hydrogen peroxide in fuel cells. In Patents US20050255341 and WO2005107002 it is reported that hydrogen peroxide is used as the oxidant in direct sodium borohydride fuel cells, and at 12 V and 70° C., a power density of 350 mW/cm² is reached and that with the usage of hydrogen peroxide the fuel cell can be used in submarine applications.

### DETAILED DESCRIPTION OF THE INVENTION

In the present invention, a 70-150 W sodium borohydride fuel cell is manufactured and operated. In the system, sodium borohydride in alkaline solution is used as the fuel and hydrogen peroxide in acid solution is used as the oxidant. The fuel and the oxidant are fed into the fuel cell, and then returning the excess fuel and oxidant to their tanks and/or mixing them with fresh fuel, are monitored through their molarities.

In a direct sodium borohydride fuel cell, sodium borohydride, which is the fuel, is converted into metaborate and water by the overall oxidation reaction (3).

Anode: NaBH₄+8OH⁻→NaBO₂+6H₂O+8e⁻E°=−1.24 (1)

Cathode: 2O₂+4H₂O+8e⁻→8OH⁻E°=0.4 (2)

Overall: NaBH₄+2O₂→NaBO₂+2H₂OE°=1.64 (3)

With a parallel reaction to the above one, however, sodium borohydride is also converted into hydrogen and metaborate according to reaction (4)

NaBH₄+2H₂O→4H₂+NaBO₂ (4)

When a liquid oxidant is fed, the reaction below takes place at the anode.

Anode: NaBH₄+8OH⁻→NaBO₂+6H₂O+8e⁻E°=−1.24 V (1)

At the cathode, however, different reactions of liquid oxidant H₂O₂ take place.

4H₂O₂→4H₂O+2O₂

2O₂+4H₂O+8e⁻→8OH⁻E°=0.4 V or

4H₂O₂+8e⁻+8e⁻→8OH⁻E°=0.87 V or

4H₂O₂+8H⁺+8e⁻→8H₂OE°=1.78 V

Overall: NaBH₄+4H₂O₂→NaBO₂+6H₂OE°=2.11 V or 3.02 V

In the direct sodium borohydride fuel cell, hydrogen is produced at the anode depending on the catalyst used and oxygen is produced on the cathode resulting from the decomposition of hydrogen peroxide. Hydrogen and oxygen gases from liquid phases of fuel and oxidant, respectively, disrupt the flow regime of the hydrogen and oxygen and hinder the contact of the fuel and oxidant with the catalyst on the anode and the cathode. This invention is related to the integration of a fuel cell system in which neither the hydrogen formed from the sodium borohydride fuel nor the oxidant from the hydrogen peroxide affects the fuel cell performance. The 70-150 W system is made up of 4 different groups (FIG. 1). These 4 different groups are made of two stacks of 7 cells, adding up to a total of 14 cells. Each cell has 25 cm² active surface area.

The fuel from the fuel storage tank (2a) and oxidant from the oxidant storage tank (2b) are pumped (by mean of 3a, 3b) to a 6-mm-wide anode side distributing unit input line (4a) and to the anode distributing unit (5a), and from the cathode side distributing unit input line (4b) to the cathode side distributing unit (5b). In the distributing units (5), anode and cathode current distributed to different feeding lines for each stack reach the cells through the 4-mm-wide anode side stack input lines (6a, 6b, 6c, 6d, 6e, 6f, 6g, 6h) and cathode side stack input lines (7a, 7b, 7c, 7d, 7e, 7f, 7g, 7h). The fuel and oxidant solutions used in the stack are transferred to the anode side collecting unit (10a) through the 4-mm anode side stack output line (8a-8h) and to the cathode side collecting unit (10b) through the cathode side stack output line (9a-9h). The streams are sent from the collecting units (10a, 10b) through the 6-mm lines (11a, 11b) back to the fuel tank (2a) and the oxidant tank (2b). The diameter of the anode and cathode side distributing unit input line (4a, and 4b) is bigger than the diameter of the anode and cathode side stack input line (6a-6h) and (7a-7h). The diameter of the anode and cathode side collecting unit output line (11a, 11b) is bigger than the diameter of the anode and cathode side stack output line (8a-8h) and (9a-9h). In this way, the circulation of the fuel and oxidant at a sufficient flow rate in each of the 7 cells is realized and the performance is increased.

The fuel and the oxidant feeding lines (12, 13) are positioned in a way that they are in the solutions in the fuel tank (2a) and the oxidant tank (2b), respectively. The levels of the anode and cathode side collecting unit output lines (11a, 11b) are above (preferably 0.5-10 cm) the feeding solution. This height and the flow rate of the returning mixture are sufficient for the homogenous mixing in the fuel and oxidant tanks. Since the anode and cathode side output lines are above the feeding solution, hydrogen formed in the fuel line in small amounts at the anode, and oxygen formed at the cathode in the oxidant line can be emptied into the air through the output lines.

Each group consists of 2 different stacks, and each stack consists of 7 different cells (FIG. 2). A stack consists of current collectors (14), monopolar plates (15), gaskets (16), membrane electrode units (17), bipolar plates (18), end plates (20a, 20b), and middle plate (21). In each group, the fuel/anode outputs and oxidant/cathode inputs of the first and second of the 7-cell-stack are on the middle plate (21) (FIG. 3). The cell number for each stack for the selected flow field design is determined by the stack performance tests. The properties of the group consisting 2 stacks each with 7 cells are to be determined by taking into consideration the weight and volume minimization as well as the ease of integration. The system integration is advantageous in this way because any problematic cell can be replaced with a new one easily and quickly in the beginning or during the operation.

The direct sodium borohydride fuel cell groups with two 7-cell-stacks are shown in FIG. 4. Anode and cathode flows are fed to two 7-cell-stacks in the countercurrent direction. The situation is depicted in FIG. 4 for anode (6a, 6b) and for cathode (7a, 7b) inputs and outputs (8a, 8b and 9a, 9b) by considering the feeding direction.

The experimental results and integration of system in the related art are described below:

In the present invention, 1 M NaBH₄ in a 6M NaOH solution is used as the fuel and 2.5 M H₂O₂ in 1.5 M H₂SO₄ solution is used as the oxidant. The fuel and the oxidant are directly fed to the fuel cell.

Nafion 117, which is a cation exchange membrane, is used as the electrolyte. The membrane is first boiled for an hour in %3 H₂O₂ (aq) and then for another hour in pure water. Finally, it is boiled for an hour in a 1 M NaOH solution. It is left in pure water and then is dried with Kimwaps paper before usage.

The anode ink was prepared from Pt-Au alloy on the Black Pearl and the cathode ink was prepared from Au catalyst on Vulcan XC 72. Both of the anode and cathode inks were applied on the carbon cloth with a 0.75 mg/cm² for anode and 1 mg/cm² for cathode.

The bipolar plates (18) used in the fuel cell stack were composite plates resistant to acid and base corrosion with serpentine flow fields. Gold plated copper plates (14) were used as the current collectors. Fuel and oxidant feeding lines (4, 6, 7, 8, and 9), gaskets (16), pumps (3a, 3b), distributing unit (5) and collecting unit (10) are made of Teflon. The sealing in the membrane electrode unit (17) consisting of membranes and electrodes and the mono/bipolar plates (15, 18) is rendered through the gaskets (16).The experiments are carried out at room temperature. Total open circuit voltage is 80-85 V.

In FIG. 5, th e of fect of 4 M hydrogen peroxide in different acid types as oxidant is investigated. Higher power densities could be reached when H₂SO₄ was used instead of HCl.

In FIG. 6, the effect of the oxidant hydrogen peroxide concentration is investigated. It was determined that the performance increased a little bit with the increase in the hydrogen peroxide concentration, but this increase was minor when compared to the increase in the peroxide concentration.

FIG. 7 shows the influence of the cathode flow rate on the performance. In a 5-cell-stack, 1 M NaBH₄ in 6 M NaOH is used as fuel, and 2.5 M H₂O₂ in 1.5 M H₂SO₄ is used as the oxidant at 25 mL/min flow rate. The tests are carried out at room temperature and the effect of the cathode side flow rate is studied. During the experiment, the voltage of each cell is measured and it is determined that the voltage varies between 1.5-1.57 V. At 25 mL/min flow rate, it was seen that especially in the cells near the output cell voltage values were below 1 V. It was observed that the performance increased when cathode flow rate was increased to 50 mL/min, but it didn't increase when cathode flow rate was increased to 75 mL/min. It was also observed that the performance wasn't affected by low current densities but increased at high current densities.

FIG. 8 shows the effect when the feeding direction of the anode and cathode solutions were investigated for a 5-cell-stack. In the case when the fuel was fed from the reverse direction, the power densities were a little bit higher.

After the production of a 5-cell-stack, a 10-cell-stack was manufactured and the voltage value of each cell was measured separately. In the performance measurements, when the cathode rate was twice the anode flow rate, the voltage of the 7 cells varied between 1.01 and 0.74 V whereas the voltage of the 3 cells varied between 0.52 and 0.58 V. Therefore, it was decided to produce stacks having 7-cell. When the stacks were produced, the ergonomic aspects of the system were also taken into consideration. In order to reduce the volume and weight of the supporting plates, group consisting 2 stacks with 7 cells were integrated. The first and the second outputs for fuel and the first and the second inputs of oxidant of the 7-cell-stack are done on the middle plate (21) through fuel side input line (6a-6h) and oxidant side input line (7a-7h), respectively.

### DESCRIPTION OF DRAWINGS

FIG. 1. The schematic drawing of the direct sodium borohydride fuel cell system (1 a anode side-1b cathode side)

FIG. 2. The schematic drawing of the 14-cell-group consisting of 2 different stacks each made up of 7 cells

FIG. 3. The detailed drawing of the middle plate used in the 14-cell-group consisting of 2 different stacks each made up of 7 cells

FIG. 4. The drawing of the input and output of the anode and cathode in the 14-cell-group consisting of 2 different stacks each made up of 7 cells

FIG. 5. The effect of acid type on the oxidant side

FIG. 6. The effect of oxidant concentration

FIG. 7. The effect of the cathode flow rate in the 5 cell stack

FIG. 8. The effect of the feeding direction of the fuel and oxidant in the 5 cell stack

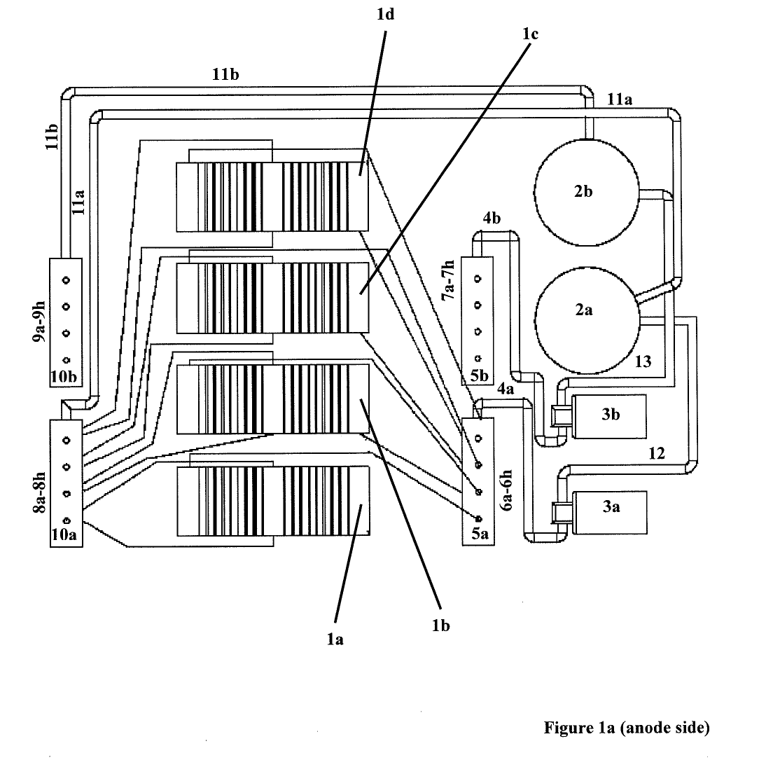

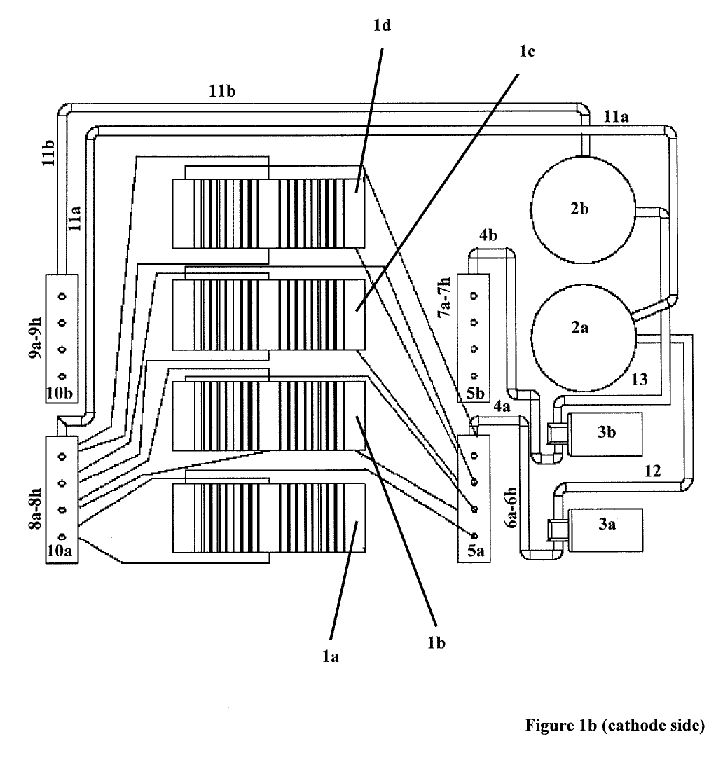

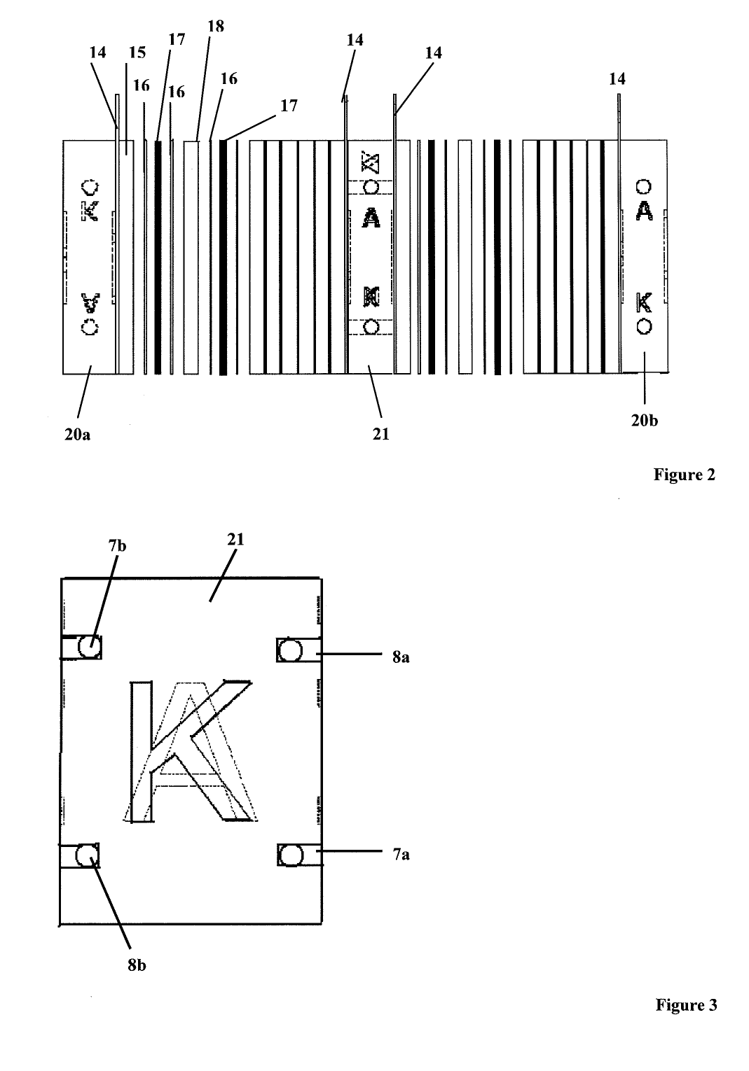

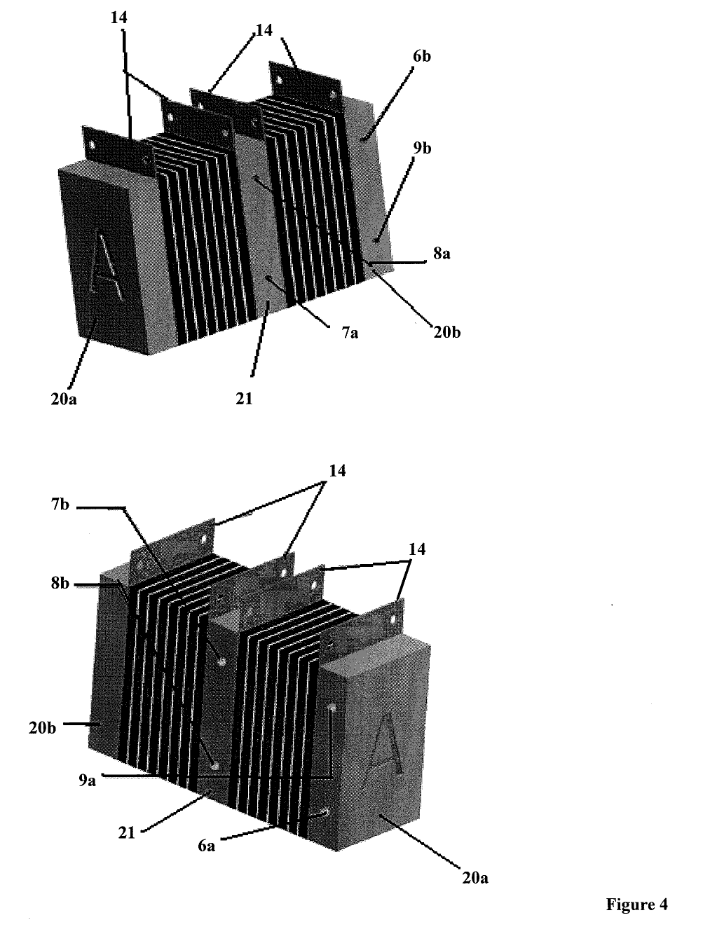

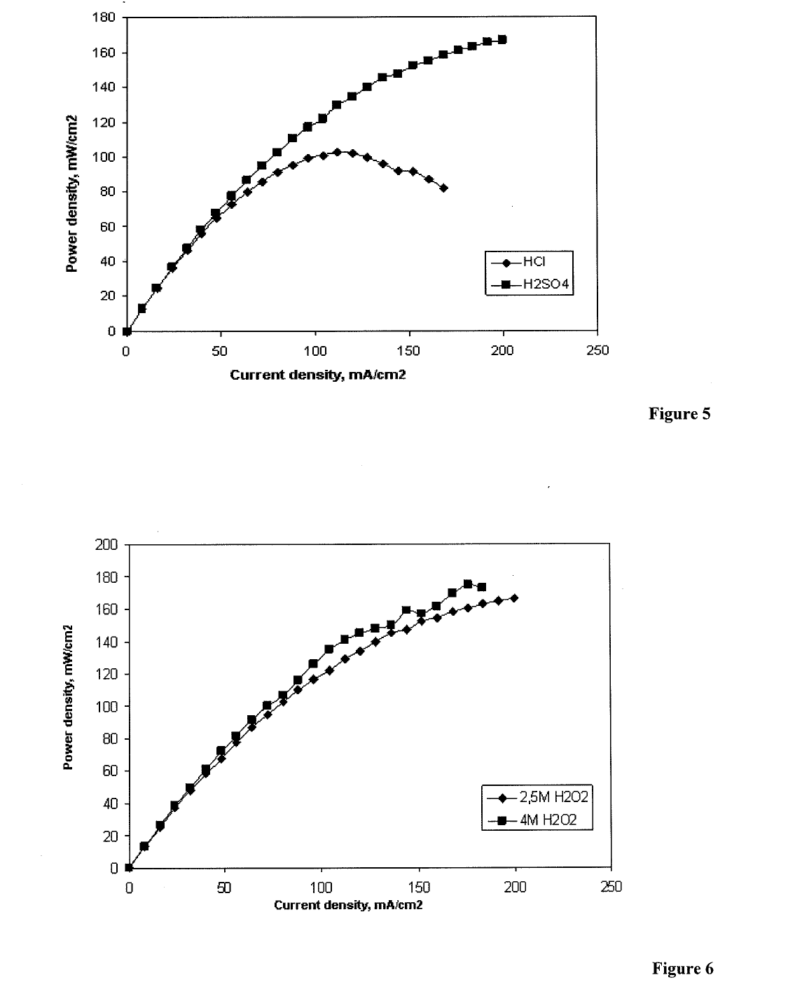

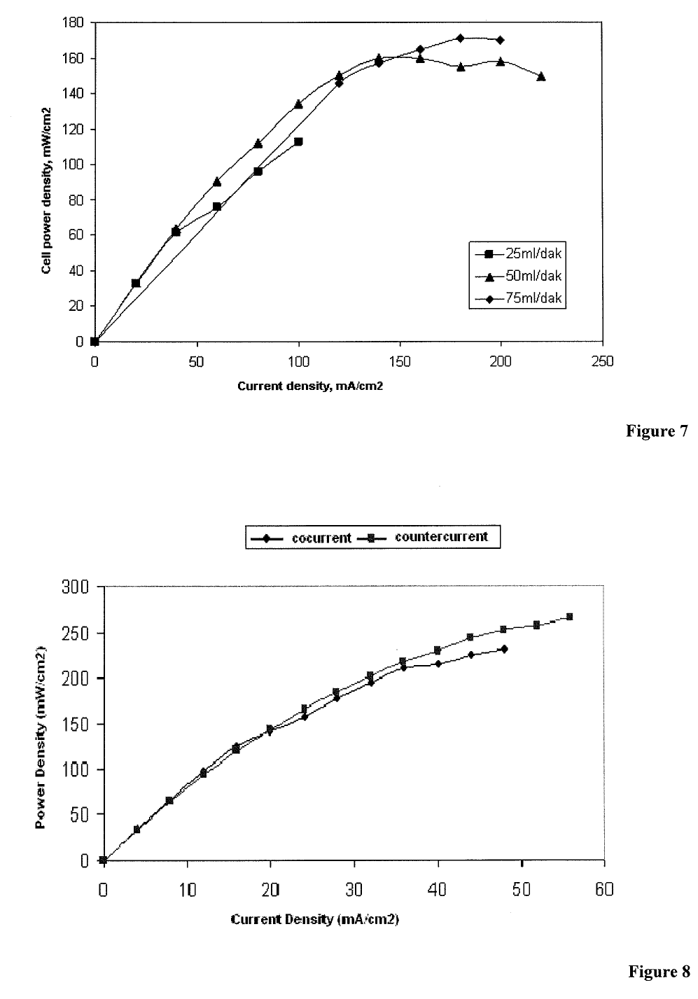

### DETAILED DESCRIPTION OF NUMBERS IN FIGURES

1 Group
1a, 1b, 1c, ld Groups consisting of 2 stacks each containing 7 cells
2 Tank
2a Fuel tank/Anode tank
3 Oxidant tank/Cathode tank
3a Pump
3a Fuel pump
3b Oxidant pump
4 Distributing Unit Input Line
4a Anode side distributing unit input line
4b Cathode side distributing unit input line
5 Distributing Unit
5a Anode side distributing unit
5b Cathode side distributing unit
6 Anode Side Stack Input line
6a, 6b, 6c, 6d, 6e, 6f, 6g, 6h
7 Cathode Side Stack Input Line
7a, 7b, 7c, 7d, 7e, 7f, 7g, 7h
8 Anode Side Stack Output Line
8a, 8b, 8c, 8d, 8e, 8f, 8g, 8h
9 Cathode Side Stack Output Line
9a, 9b, 9c, 9d, 9e, 9f, 9g, 9h
10 Collecting Unit
10a Anode side collecting unit
10b Cathode side collecting unit
11 Collecting Unit Output Line
11a Anode side collecting unit output line
11b Cathode side collecting unit output line
12 Fuel feeding line
13 Oxidant feeding line
14 Current collector
15 Flow plate machined only on one side/monopolar plate
16 Gasket
17 Membrane electrode assembly
18 Bipolar plate
20 End plate (a, b)
21 Middle plate

1.-16. (canceled)

17. A portable fuel cell system comprising multiple modules and multiple cells in said modules, the fuel cell system generating energy by hydrogen formed from sodium borohydride and oxygen formed from hydrogen peroxide (aq), the fuel cell system further comprising;
a) independent 4 groups (1a, 1b, 1c, 1d) each consisting of 2 stacks made up of 7 cells each of which are electrically connected to each other in series, in which the fuel and the oxidant are only fed to said stacks,
b) a common plate (21) which is used by both of said 2 sub-stacks and in between said 2 stacks in each group (1a, 1b, 1c, 1d),
c) a corrosion resistant current collector (14) placed next to an anode and a cathode of a 7-cell stack,
d) pumps (3a, 3b) for pumping fuel and oxidant from storage tanks through an anode (4a) side and a cathode (4b) side distributing unit input lines,
e) a distributing unit (5a) having minimum 8 distributing points for anode input flow and a collecting unit (10a) having minimum 8 collecting point for anode output flow,
f) a distributing unit (5b) having minimum 8 distributing points for cathode input flow and a collecting unit (10b) having minimum 8 collecting points for cathode output flow.

18. The fuel cell system of claim 17, wherein diameters of said input lines to the anode and cathode side distributing units (4a and 4b) are larger than the diameter of the output lines of anode and cathode side distributing units (6a-6h and 7a-7h).

19. The fuel cell system of claim 17, wherein diameters of said output line of the anode and cathode side collecting units (11a and 11b) are larger than the input lines of the anode and cathode side collecting units (8a-8h and 9a-9h), respectively.

20. The fuel cell system of claim 17, wherein the fuel and the oxidant enter the 7-cell stack through different lines (6a-6h and 7a-7h) and exit from the stack through different lines (8a-8h and 9a-9h).

21. The fuel cell system of claim 17, wherein the fuel cell stacks are bipolar.

22. The fuel cell system of claim 17 wherein the fuel fed to said cell is sodium borohydride in NaOH solution and the oxidant fed to said cell is a hydrogen peroxide in an inorganic acid solution.

23. A method of generating energy in a fuel cell using sodium borohydride (Na BH₄) and an oxidant, the method comprising the steps of:
a) simultaneous transportation of a fuel and an oxidant solution from a fuel tank (2a) and an oxidant tank (2b) with a fuel pump (3a) and an oxidant pump (3b) to an anode and a cathode, respectively,
b) distributing fuel from said fuel storage tank from the anode side distributing unit input line (4a) with a pump (3a) through said anode side distributing unit (5a) to fuel cell stacks (1a, 1b, 1c, 1d) comprising a plurality of cells having as many distribution points as the number of the stacks,
c) collecting the fuel from the fuel cell stacks in a collecting unit (10a) and then sending the same back to the fuel tank (2a),
d) mixing said fuel which is freed from hydrogen with the fuel in the fuel tank (2a) and then feeding the mixed fuel to the anode again, and then repeating the steps a and c above,
e) distributing said oxidant from the oxidant storage tank from the cathode side distributing unit input line (4b) with a distributing unit (5b) having more than one distribution point to fuel cell stacks,
f) collecting the oxidant from the fuel cell stacks in a collecting unit (10b) having as many inputs as the number of the stacks in the fuel cell and then sending the same back to said oxidant tank (2b).
g) mixing the oxidant freed from oxygen with the oxidant in the oxidant tank (2b), and then sending the mixture to the cathode, and subsequently, then repeating the steps e to f.

24. The method of claim 23, wherein hydrogen gas formed by an unwanted hydrolysis reaction of sodium borohydride coming from the anode side collecting unit output line to the anode tank is removed.

25. The method of claim 23, wherein the fuel feeding line (12) is kept in the solution in the fuel tank (2) and the anode side collecting unit output line (11a) is kept above the anode feeding solution.

26. The method of claim 23, wherein oxygen gas formed by the decomposition of hydrogen peroxide coming from the cathode side collecting unit output line (11b) to the cathode tank is removed.

27. The method of claim 23, wherein the oxidant feeding line (13) is kept in the solution in the oxidant tank (2b) and the cathode side collecting unit output line (11b) is kept above the feeding solution.

28. The method of claim 23 wherein the mole ratio of the oxidant to the fuel is between 2:1 and 6:1 and preferably 4:1.

29. The method of claim 23 wherein stabilization of the fuel is made with 3-7 M NaOH and preferably with 6 M NaOH.

30. The method of claim 23 wherein the ratio of the flow rate of the oxidant to the flow rate of the fuel is between 1 and 3.

31. The method of claim 23 wherein anode and cathode solutions are fed to anode and cathode, respectively as concurrently or counter-currently, and preferably counter-currently.
